(19) United States
(12) Patent Application Publication
(10) Pub. No.: US 2016/0009049 A1
(43) Pub. Date: Jan. 14, 2016

(54) NANOPOROUS MEMBRANES AND METHODS FOR MAKING THE SAME

(71) Applicant: LOCKHEED MARTIN CORPORATION, Bethesda, MD (US)

(72) Inventors: Randall M. STOLTENBERG, Palo Alto, CA (US); Peter V. BEDWORTH, Los Gatos, CA (US); Scott E. HEISE, San Jose, CA (US); Steven W. SINTON, Palo Alto, CA (US); Jacob L. SWETT, Redwood City, CA (US)

(21) Appl. No.: 14/858,741

(22) Filed: Sep. 18, 2015

Related U.S. Application Data
(63) Continuation-in-part of application No. 14/200,530, filed on Mar. 7, 2014.
(60) Provisional application No. 61/779,098, filed on Mar. 13, 2013.

(51) Int. Cl. B32B 3/26; B01D 69/10; B01D 69/12; B01D 71/02; B32B 9/00; B01D 67/00

(52) U.S. Cl. CPC B32B 3/266; B32B 9/00; B32B 9/007; B01D 67/0062; B01D 69/122; B01D 71/021; B01D 69/10; B01D 2325/028

(57) ABSTRACT

A method for making a nanoporous membrane is disclosed. The method provides a composite film comprising a two-dimensional material layer and a polymer layer, and then bombarding the composite film with energetic particles to form a plurality of pores through at least the two-dimensional material layer. The nanoporous membrane also has a two-dimensional material layer with a plurality of apertures therethrough and a polymer film layer adjacent one side of the graphene layer. The polymer film layer has a plurality of enlarged pores therethrough, which are aligned with the plurality of apertures. All of the enlarged pores may be concentrically aligned with all the apertures. In one embodiment the two-dimensional material layer is graphene.

### CROSS REFERENCE TO RELATED APPLICATION

This application is a continuation-in-part of U.S. patent application Ser. No. 14/200,530, filed Mar. 7, 2014, which claims priority of Provisional Application Ser. No. 61/779,098 filed Mar. 13, 2013, each of which is incorporated herein by reference in its entirety.

### TECHNICAL FIELD

Generally, the present invention is directed toward a nanoporous membrane and methods for making the membrane. More particularly, the present invention is directed to a composite membrane made up of a perforated two-dimensional layer of material and a support layer wherein nanosize holes are provided in the two-dimensional layer and concentric nanosize or microsize holes are provided in the support layer.

### BACKGROUND ART

The ability to manipulate individual atoms for use in nanotechnology components continues to develop. Some of these developments are in the field of materials and specifically atomically thin materials which may use a single molecular component or selected combinations of molecular components. One example of such a material is graphene which is a two-dimensional aromatic carbon polymer that has a multitude of applications ranging from electronic memory, electrical storage, composite enhancement, membranes and the like. Other atomically thin materials are believed to have their own beneficial properties.

One non-limiting example of an atomically thin material is graphene. A graphene membrane is a single-atomic-thick layer of carbon atoms, bound together to define a sheet. The thickness of a single graphene membrane, which may be referred to as a layer or a sheet, is approximately 0.34 nanometers (nm) thick, or as sometimes referred to herein “thin.” The carbon atoms of the graphene layer define a pattern of interlocking hexagonal ring structures (benzene rings) constructed of six carbon atoms, which form a honeycomb lattice of carbon atoms. An interstitial aperture is formed by each six carbon atom ring structure in the sheet and this interstitial aperture is less than one nanometer across. Indeed, skilled artisans will appreciate that the interstitial aperture is believed to be about 0.23 nanometers across at its longest dimension (distance from the center of the atoms. Accordingly, the dimension and configuration of the interstitial aperture and the electron nature of the graphene precludes transport of any molecule across the graphene's thickness unless there are perforations.

Other two-dimensional materials having a thickness of a few nanometers or less and an extended planar lattice are also of interest for various applications. In an embodiment, a two dimensional material has a thickness of 0.3 to 1.2 nm. In other embodiment, a two dimensional material has a thickness of 0.3 to 3 nm For example, molybdenum disulfide is a representative chalcogenide having a two-dimensional molecular structure, and other various chalcogenides can constitute the two-dimensional material in the present disclosure. Other two dimensional materials include, but are not limited to, few layer graphene, molybdenum disulfide, boron nitride, hexagonal boron nitride, niobium diselenide, silicene, and germanene.

Recent developments have focused upon graphene membranes for use as filtration membranes in applications such as salt water desalination. One example of such an application is disclosed in U.S. Pat. No. 8,361,321 which is incorporated herein by reference. As these various uses of graphene and other atomically thin materials develop, there is a need to manufacture materials and supporting substrates which have nano or micro size apertures or holes.

Nanoporous membranes which have a pore size of 0.1-100 nm are difficult to manufacture because the membrane must typically be extremely thin to allow such a small pore size to persist throughout the membranes' thickness. Accordingly, the membrane bearing the pore is typically supported on a thicker porous substrate to imbue the final composite membrane with sufficient mechanical strength.

A current method of making such a composite membrane uses perforated graphene (thickness about 0.34 nm) as an active membrane material and a porous polycarbonate film or polyimide film (thickness about 5-10 μm) as the supporting substrate. These two layers may be mated to one another after the holes in each are already made or the holes may be added to the graphene after it is applied to the porous polycarbonate or polyimide substrate. The holes in both substrates are not registered or aligned with one another, hence flow through the composite membrane is limited by the statistics of overlapping holes. In other words, flow through the composite membrane is limited based on the random alignment of the holes in the graphene membrane material coincidentally aligning with the holes of the porous polycarbonate film.

The mating of perforated atomically thin materials, such as graphene, and porous support films to create composite membranes for nanofiltration are believed to provide an improvement over other filtration type membranes. Other nanoporous membranes are made of thicker polymer films with tortuous paths that demonstrate nanoscale exclusion, but they typically have extremely low permeability as a result of their thickness and tortuosity.

### SUMMARY OF THE INVENTION

In light of the foregoing, it is a first aspect of the present invention to provide nanoporous membranes and methods for making the same.

In another aspect, the present disclosure provides methods for making a nanoporous membranes and supported nanoporous membranes. In embodiments, a method comprises the steps of providing a composite structure comprising a layer of a two-dimensional material disposed on a support and irradiating the composite structure with energetic particles to form a plurality of perforations or pores through at least the two-dimensional material. A supported nanoporous membrane is provided by the layer of perforated two-dimensional material disposed on the support. In further embodiments, at least some of the pores etched through the layer of support material are aligned with the perforations or pores through the layer of two-dimensional material. Alignment of the pores of the support material and the perforations of the two-dimensional material can increase flow through the composite membrane as compared to a similar membrane lacking such alignment. In some embodiments, the perforations in the two-dimensional material are from 0.4 nm to 100 nm in size. In further embodiments, the two-dimensional material is a graphene-based material comprising single layer graphene, multi-layer graphene, multiple layers of single layer graphene or multiple layers of multi-layer graphene.

It is another aspect of the present invention to provide a method for making a nanoporous membrane, the method comprising providing a composite film, the composite film comprising an atomically thin material layer and a polymer film, and bombarding the composite film with energetic particles to form a plurality of pores through at least the atomically thin material layer. The polymer film may serve as a support.

In some embodiments, the support of the composite structure or film comprises at least one layer of track etchable material and the energetic particles form damage tracks through the layer(s) of track etchable material during the irradiation of the composite structure or film. In further embodiments, the damage tracks formed by passage of the energetic particles through the layer of support material include pores formed through the layer of support material. It is another aspect of the present disclosure to provide for selecting energetic particles so as to form the plurality of holes through the two-dimensional material layer and the polymer film so that the polymer film is chemically functionalized. In another mode of this method, the energetic particles may be selected so as to leave the polymer film chemically inert toward pore enlargement. And the method may include chemically bonding the atomically thin material layer to the polymer film during bombarding. In yet a further aspect of the invention, the energetic particles do not pass through the support material and no damage track is created entirely through the support material. Instead a small pit is created in the support material at its interface with the two-dimensional material.

In a further aspect of the invention, the at least one layer of track etchable material is irradiated prior to application of the two-dimensional material to the composite structure. The track etchable material may be further irradiated during perforation of the two-dimensional material.

In different embodiments, the energetic particles pass through the two-dimensional material before passing through the support material or after passing through the support material. In yet a further embodiment, the energetic particles is screened by a porous template material (i.e. a shadow mask) before impacting either the support material or the two-dimensional material. In an example, the screen is used to limit irradiation of the support material and the two-dimensional material to select regions, thereby limiting the extent of perforation of the two dimensional material and pore formation in the support. Limiting perforation of the two-dimensional material to select regions can limit reduction in the strength of the two-dimensional material by the introduction of perforations.

In an example, the energetic particles are directed substantially normal to the composite structure. In an additional example, the composite structure is irradiated by energetic particles directed at a first angle from 0 degrees to 45 degrees with respect to the normal to the composite structure. In a further example, the composite structure is irradiated by energetic particles directed at a first angle from 0 degrees to 45 degrees with respect to the normal to the composite structure and then irradiated by energetic particles directed at a second angle from 0 degrees to 45 degrees, the second angle being different from the first angle. In a further embodiment, irradiation may occur at an arbitrary angle, such as irradiation from a non-collimated source.

In additional embodiments, the method further comprises applying an etchant to the support material thereby etching at least a plurality of the damage tracks to form pores through the layer(s) of track etchable material. The etching conditions are selected to produce the desired shape and size of the pores in the track etchable material. For example, if the damage tracks are etched only from one face of the track etchable material, the pore size at that face tends to be larger than at the opposite face and a conical or frustoconical pore shape may be produced. The track etchable material may also be exposed to ultraviolet light following irradiation. If irradiation of the composite structure produces a damage pit rather than a damage track, this pit can be used as an initiating point for etching.

In an embodiment, the etching process is performed in more than one step. For example, a first etching step is performed so that the support structure is not completely etched through the thickness. An additional irradiation step may be performed prior to the second etching step. In an example, where the first etching step is performed through the layer of two dimensional material, this second irradiation step is performed so that the energetic particles first contact the substrate material. The irradiation conditions in this second step may be selected so that the energetic particles do not reach the layer of two dimensional material. For example, the additional irradiation step may direct the energetic particles at a greater angle with respect to the normal to the composite structure.

In further embodiments, etchant is applied to the layer of two-dimensional material. In different embodiments, etchant is applied to the layer of two-dimensional material before being applied to the support, after being applied to the support, or at the same time as being applied to the support.

In an example, the etchant applied to the layer of two-dimensional material is the same as that applied to the support and may be applied by immersing the composite structure in the etchant. In this example, damage tracks are etched from both faces of the layer of track etchable material. However, flow of etchant through the pores in the two-dimensional material may be restricted by the pores in the two-dimensional material. In an embodiment, the additional etchant does not substantially etch the layer of two-dimensional material. In yet further embodiments, the additional etchant is selected to etch the two-dimensional material.

In embodiments, the support comprises one or more layers of track etchable material. In some embodiments, the support comprises a single layer of track etchable material. In an embodiment where the support comprises more than one layer of track etchable material, the material of layers may be selected to provide different etching properties.

In some embodiments described above, the etching step(s) follow the irradiation step(s). In yet a further aspect of the invention, an etching step is inserted between two irradiation steps. For example, irradiation of the support and/or graphene may be followed by etching of the support followed in turn by irradiation of the graphene to perforate the graphene. The last irradiation step may occur through the substrate. Such a method may allow production of relatively large substrate apertures.

It is yet another aspect of the above embodiments to provide for etching a polymer film to form a plurality of enlarged pores in the polymer film. It is still another aspect of the above embodiment to provide for each of the plurality of enlarged pores so that they are substantially aligned with one of the plurality of pores through the two-dimensional material layer.

It is a further another aspect of the above embodiments to provide for the plurality of pores or perforations through the two-dimensional material layer ranges in size from 0.3 nm to about 100 nm, 0.4 nm to about 100 nm, or from 0.5 nm to about 100 nm, from 0.3 nm to about 10 nm, from 0.4 nm to about 10 nm, for from 0.5 nm to about 10 nm, wherein the plurality of enlarged pores from 10 nm to 1000 nm, and wherein the plurality of enlarged pores so that they have a diameter larger than the plurality of pores. The method may also include controlling the bombarding and etching so that the plurality of enlarged pores have a diameter larger than the plurality of pores.

It is yet another aspect of the above embodiment to provide the two-dimensional material layer as a single atomic layer of carbon material, or to provide the two-dimensional material layer as multiple atomic layers of carbon material. The method may also include selecting the two-dimensional material from the group consisting of graphene, few layer graphene, molybdenum disulfide, boron nitride, hexagonal boron nitride, niobium diselenide, silicene, germanene and combinations thereof.

Still a further aspect of the method is to utilize polycarbonate as the polymeric film. Another aspect of the method is to provide a porous polymer film as part of the composite film or structure.

And the method may provide that the plurality of pores through the two-dimensional material layer range in size from about 0.5 nm to about 10 nm.

Still another aspect of the present invention is to provide a nanoporous membrane comprising an two-dimensional material layer having a plurality of apertures therethrough, and a track etchable layer adjacent one side of the two-dimensional material layer, the track etchable layer having a plurality of enlarged pores therethrough, wherein the plurality of enlarged pores are aligned with the plurality of apertures.

In one variation of the above aspect, the membrane may be constructed so that the plurality of apertures can range in diameter from 0.5 nm to 10 nm, and wherein the plurality of enlarged pores range in diameter from 10 nm to 1000 nm, from 10 nm to 5000 nm or from 100 nm to 5000 nm.

In another variation of the above aspect, the membrane may be constructed so that the pluralities of enlarged pores have a diameter larger than the plurality of apertures.

In still another variation of the above aspect, the membrane may be constructed so that the two-dimensional material layer is chemically bonded to the track etchable layer, at an edge of the plurality of apertures.

And yet another variation of the above aspect is that the membrane may be constructed so that substantially all of the pluralities of enlarged pores are concentrically aligned with the plurality of apertures.

In an example, the layer of two-dimensional material is disposed on a first face of the layer of track etchable material. In another example, a spallation modifying layer is disposed between the layer of track etchable material and the layer of two-dimensional material. For example, a first face of the layer of track etchable material is disposed on a first face of the spallation modification layer and the layer of two-dimensional material is disposed on the second face of the spallation modification layer, the second face of the spallation modification layer being opposite the first face. In different embodiments, the spallation modifying layer provides an increases amount of spallation as compared to the underlying support layer or provides a decreased amount of as compared to the underlying support layer. As further examples, a pore or a damage track is formed in the spallation modification layer during irradiation with the energetic particles. As one example, the irradiation produces a damaged region that includes a pore in the spallation modification layer. In a further example, the pore formed in the damaged region is selectively etched to dilate the produced pore. In yet another example, irradiation produces a damage region in the spallation modification layer that is etched to produce a pore or porous region. In an embodiment, the formation of pores in the spallation modification layer forms a nanoporous or solution-diffusion like membrane from this layer. In an example, the pores formed in the spallation modification layer are intermediate in size between the perforations in the 2D material and the tracked etched substrate. In embodiments, the etchant is applied to a second face of the layer of track etchable material, the second face of the layer of track etchable material being opposite the first face.

In a further aspect, the invention provides a method for making a supported membrane comprising a nanopore, the method comprising the steps of
a) providing a composite structure comprising a layer of a two-dimensional material disposed on a support, wherein the support comprises at least one layer of track etchable material;
b) irradiating said composite structure with an energetic particle to form a single perforation in at least said layer of two-dimensional material and to form a damage track through the layer of track etchable material; and
c) applying a track etchant to the support material, thereby etching a track to form a pore through the layer of track etchable material
   whereby a supported nanoporous membrane is provided by the layer of perforated two-dimensional material disposed on the support. A membrane comprising a single nanopore is also provided, this membrane comprising an two-dimensional material layer having a single perforation therethrough, and a track etchable layer adjacent one side of the two-dimensional material layer, the track etchable layer having at least one enlarged pores therethrough, wherein enlarged pore(s) are aligned with the perforation in the two-dimensional material.

A further variation of the above aspects is that the two-dimensional material layer may be selected from the group consisting of graphene, few layer graphene, graphene-based material, molybdenum disulfide, boron nitride, hexagonal boron nitride, niobium diselenide, silicene, and germanene and combinations thereof. In an embodiment, the two-dimensional material comprises single layer graphene, multi-layer graphene, multiple layers of single layer graphene or multiple layers of multi-layer graphene.

### BRIEF DESCRIPTION OF THE DRAWINGS

These and other features and advantages of the present invention will become better understood with regard to the following description, appended claims, and accompanying drawings. The figures may or may not be drawn to scale and proportions of certain parts may be exaggerated for convenience of illustration.

FIG. 1 is a schematic diagram of a process according to the concepts of the present invention for making a nanoporous membrane with an initially non-porous polymer film; and

FIG. 2 is a schematic diagram of a process according to the concepts of the present invention for making a nanoporous membrane with an initially porous polymer film.

### DETAILED DESCRIPTION

Graphene represents a form of carbon in which the carbon atoms reside within a single atomically thin sheet or a few layered sheets (e.g., about 20 or less) of fused six-membered rings forming an extended sp²-hybridized carbon planar lattice. Graphene-based materials include, but are not limited to, single layer graphene, multilayer graphene or interconnected single or multilayer graphene domains and combinations thereof. In embodiments, multilayer graphene includes 2 to 20 layers, 2 to 10 layers or 2 to 5 layers. In an embodiment, layers of multilayered graphene are stacked, but are less ordered in the z direction (perpendicular to the basal plane) than a thin graphite crystal.

In an embodiment, graphene-based materials also include materials which have been formed by stacking single or multilayer graphene sheets. For example, a sheet of single layer graphene (SLG) is layered via float-down on top of a substrate or support. Another sheet of the SLG is then floated it down on the already prepared SLG-substrate/support stack. This would now be 2 layers of “as synthesized” SLG on top of the substrate or support. This could be extended to few layer graphene (FLG) or a mixture of SLG and FLG; and could be achieved through transfer methods known to the art.

In an embodiment, a sheet of graphene-based material is a sheet of single or multilayer graphene or a sheet comprising a plurality of interconnected single or multilayer graphene domains. In embodiments, the multilayer graphene domains have 2 to 5 layers or 2 to 10 layers. As used herein, a “domain” refers to a region of a material where atoms are uniformly ordered into a crystal lattice. A domain is uniform within its boundaries, but different from a neighboring region. For example, a single crystalline material has a single domain of ordered atoms. In an embodiment, at least some of the graphene domains are nanocrystals, having domain size from 1 to 100 nm or 10-100 nm. In an embodiment, at least some of the graphene domains have a domain size greater than 100 nm to 1 micron, or from 200 nm to 800 nm, or from 300 nm to 500 nm. In an embodiment, a domain of multilayer graphene may overlap a neighboring domain. “Grain boundaries” formed by crystallographic defects at edges of each domain differentiate between neighboring crystal lattices. In some embodiments, a first crystal lattice may be rotated relative to a second crystal lattice, by rotation about an axis perpendicular to the plane of a sheet, such that the two lattices differ in “crystal lattice orientation”.

In an embodiment, the sheet of graphene-based material is a sheet of multilayer graphene or a combination of single and multilayer graphene. In another embodiment, the sheet of graphene-based material is a sheet comprising a plurality of interconnected multilayer or single and multilayer graphene domains. In an embodiment, the interconnected domains are covalently bonded together to form the sheet. When the domains in a sheet differ in crystal lattice orientation, the sheet is polycrystalline.

In embodiments, the thickness of the sheet of graphene-based material is from 0.34 to 10 nm, from 0.34 to 5 nm, or from 0.34 to 3 nm. In an embodiment, the thickness includes both single layer graphene and the non-graphenic carbon.

In an embodiment, a sheet of graphene-based material comprises intrinsic defects. Intrinsic defects are those resulting from preparation of the graphene-based material in contrast to perforations which are selectively introduced into a sheet of graphene-based material or a sheet of graphene. Such intrinsic defects include, but are not limited to, lattice anomalies, pores, tears, cracks or wrinkles. Lattice anomalies can include, but are not limited to, carbon rings with other than 6 members (e.g. 5, 7 or 9 membered rings), vacancies, interstitial defects (including incorporation of non-carbon atoms in the lattice), and grain boundaries. As used herein, perforations do not include openings in the graphene lattice due to intrinsic defects or grain boundaries.

In embodiments, graphene is the dominant material in a graphene-based material. For example, a graphene-based material comprises at least 20% graphene, 30% graphene, or at least 40% graphene, or at least 50% graphene, or at least 60% graphene, or at least 70% graphene, or at least 80% graphene, or at least 90% graphene, or at least 95% graphene. In embodiments, a graphene-based material comprises a range of graphene selected from 30% to 95%, or from 40% to 80% from 50% to 70%, from 60% to 95% or from 75% to 100%. In an embodiment, the amount of graphene in the graphene-based material is measured as an atomic percentage.

In an embodiment, a sheet of graphene-based material further comprises non-graphenic carbon-based material located on a surface of the sheet of graphene-based material. In an embodiment, the sheet is defined by two base surfaces (e.g. top and bottom faces of the sheet) and side faces. In a further embodiment, the “bottom” face of the sheet is that face which contacted the substrate during growth of the sheet and the “free” face of the sheet opposite the “bottom” face. In an embodiment, non-graphenic carbon-based material is located on a base surface of the sheet (e.g. the substrate side of the sheet and/or the free surface of the sheet). In a further embodiment, the sheet of graphene-based material includes a small amount of one or more other materials on the surface, such as, but not limited to, one or more dust particles or similar contaminants.

In an embodiment, the amount of non-graphenic carbon-based material is less than the amount of graphene. In embodiments, the surface coverage of the sheet of non-graphenic carbon-based material is greater than zero and less than 80%, from 5% to 80%, from 10% to 80%, from 5% to 50% or from 10% to 50%. This surface coverage may be measured with transmission electron microscopy, which gives a projection. In embodiments, the amount of graphene in the graphene-based material is from 60% to 95% or from 75% to 100%.

In an embodiment, the non-graphenic carbon-based material does not possess long range order and may be classified as amorphous. In embodiments, the non-graphenic carbon-based material further comprises elements other than carbon and/or hydrocarbons. In an embodiment, non-carbon elements which may be incorporated in the non-graphenic carbon include hydrogen, oxygen, silicon, copper and iron. In further embodiment, the non-graphenic carbon-based material comprises hydrocarbons. In embodiments, carbon is the dominant material in non-graphenic carbon-based material. For example, a non-graphenic carbon-based material comprises at least 30% carbon, or at least 40% carbon, or at least 50% carbon, or at least 60% carbon, or at least 70% carbon, or at least 80% carbon, or at least 90% carbon, or at least 95% carbon. In embodiments, a non-graphenic carbon-based material comprises a range of carbon selected from 30% to 95%, or from 40% to 80%, or from 50% to 70%. In an embodiment, the amount of carbon in the non-graphenic carbon-based material is measured as an atomic percentage.

In further embodiments, the sheet of graphene based material is larger than a flake which would be obtained by exfoliation. For example, the sheet has a lateral dimension greater than about 1 micrometer. As used herein, a lateral dimension is perpendicular to the thickness of the sheet.

Illustrative chemical etchants for use with graphenic two-dimensional material include oxidants such as, for example, ozone, potassium permanganate, sulfuric acid and combinations thereof and modified Hummer's solution. In an embodiment, the oxidant combines NaNO₃, H2SO₄ and KMnO₄. Other strong oxidants may also be suitable and will be recognized by one having ordinary skill in the art. An exemplary etch time is 0.1 to 1 hr at room temperature. In an embodiment, these conditions are suitable for 0.1% modified Hummer's solution. UV-oxygen based etching methods include methods in which the graphene-based material is simultaneously exposed to ultraviolet (UV) light and an oxygen containing gas. Ozone may be generated by exposure of an oxygen containing gas such as oxygen or air to the UV light, in which case the graphene-based material is exposed to oxygen. Ozone may also be supplied by an ozone generator device. In an embodiment, the UV-ozone based perforation method further includes exposure of the graphene-based material to atomic oxygen. Suitable wavelengths of UV light include, but are not limited to wavelengths below 300 nm or from 150 nm to 300 nm. Inn embodiments, the intensity from 10 to 100 mW/cm² at 6 mm distance or 100 to 1000 mW/cm² at 6 mm distance. For example, suitable light is emitted by mercury discharge lamps (e.g. about 185 nm and 254 nm). In embodiments, UV/ozone etching is performed at room temperature or at a temperature greater than room temperature. In further embodiments, UV/ozone etching is performed at atmospheric pressure (e.g. 1 atm) or under vacuum.

Nanomaterials in which pores are intentionally created will be referred to herein as “perforated graphene”, “perforated graphene-based materials” or “perforated two-dimensional materials.” The size distribution of holes may be narrow, e.g., limited to 0.1 to 0.5 coefficient of variation. In an embodiment, the characteristic dimension of the holes is selected for the application. For circular holes, the characteristic dimension is the diameter of the hole. In embodiments relevant to non-circular pores, the characteristic dimension can be taken as the largest distance spanning the hole, the smallest distance spanning the hole, the average of the largest and smallest distance spanning the hole, or an equivalent diameter based on the in-plane area of the pore. As used herein, perforated graphene-based materials include materials in which non-carbon atoms have been incorporated at the edges of the pores. In embodiments, the pore is asymmetric with the pore size varying along the length of the hole (e.g. pore size wider at the free surface of the graphene-based material than at the substrate surface or vice versa. In an embodiment, the pore size may be measured at one surface of the sheet of graphene based material.

Quantitative image analysis of pore features may include measurement of the number, area, size and/or perimeter of pore features. In an embodiment, the equivalent diameter of each pore is calculated from the equation A=πd²/4. When the pore area is plotted as a function of equivalent pore diameter, a pore size distribution is obtained. The coefficient of variation of the pore size is calculated herein as the ratio of the standard deviation of the pore size to the mean of the pore size.

In an embodiment, the ratio of the area of the perforations to the ratio of the area of the sheet is used to characterize the sheet. The area of the perforations may be measured using quantitative image analysis. The area of the sheet may be taken as the planar area spanned by the sheet if it is desired to exclude the additional sheet surface area due to wrinkles or other non-planar features of the sheet. In a further embodiment, characterization may be based on the ratio of the area of the perforations to the sheet area excluding features such as surface debris. In embodiments, the perforated area comprises 0.1% or greater, 1% or greater or 5% or greater of the sheet area, less than 10% of the sheet area, less than 15% of the sheet area, from 0.1% to 15% of the sheet area, from 1% to 15% of the sheet area, from 5% to 15% of the sheet area or from 1% to 10% of the sheet area. In a further embodiment, the perforations are located over greater than 10% or greater than 15% of said area of said sheet of graphene-based material.

Suitable energetic particles include ions, neutrons, protons, ions, ion clusters and the like that are sufficiently energetic to traverse the composite structure or film. In embodiments, the energy of the particles is greater than 1 MeV/micron thickness. In some embodiments with polymer supports the energy is 2 to 4 keV per nm In further embodiments, the energy of the particles is 0.1 MeV-10,000 MeV, 0.1 MeV-5,000 MeV, 0.1 MeV-1,000 MeV, 0.1 MeV-100 MeV, 100 MeV-5,000 MeV or 1,000 MeV to 5,000 MeV. In an embodiment, a fluence between 10⁶ ions/cm² and 10¹³ ions/cm² is directed toward the composite structure or film. In some embodiments lower fluences are used. In an example a single ion is allowed to irradiate the composite. In embodiments the particles are charged particles such as protons or ions of He, Ne, Ar, Kr, or Xe.

In embodiments disclosed herein, the support of either the composite structure or the composite membrane provides mechanical support. In many embodiments, the thickness of the support is significantly greater than that of the two-dimensional material. In an embodiment, the thickness of the support is from 100 nm to 100 microns. In embodiments, the support may be formed of a single layer of track etchable material or of multiple layers of track etchable materials. In an embodiment, the combined thickness of a support formed of multiple layers is 100 nm to 100 microns. The support of the composite structure may be porous or nonporous prior to irradiation. In many of the embodiments provided herein, the support of the composite membrane has no through porosity before irradiation and is porous following irradiation and etching.

In embodiments, the support of the composite structure comprises at least one layer of a “track etchable” material. As is known to the art, such materials are damaged by in such a way by the passage of energetic particles that the particle tracks can be developed by subsequent etching and observed (e.g. through use of a microscope). Such materials may also be referred to as detector materials. Track etchable materials include, but are not limited to polymers, inorganic glasses, mineral crystals (e.g. mica), oxide semiconductors, intermetallic compounds and silicon nitride. Suitable polymers include, but are not limited to, polycarbonate, polyimide, polyester, polypropylene, polyvinylidene fluoride, poly methyl methacrylate and polyethylene terephthalate (abbreviated as PET). Track etchable materials are typically dielectric materials. Suitable etchants for track etchable materials are known to the art. For polymer substrates, suitable etchants include aqueous solutions of NaOH. For various inorganic substrates, suitable etchants include aqueous solutions of HF and, for silicate substrates, aqueous solutions of NaOH. In embodiments, ultraviolet light (UV) sensitization of the track etchable material as known in the art is performed prior to etching.

In some embodiments, the energetic particles create a plurality of damage tracks in one or more layers of the support as they pass through. As used herein, the term “damage track” refers to the modified zone created along the trajectory of energetic ions passing through sensitive materials. In some embodiments, the damage track may be viewed as having a core and a halo which surrounds the core. In a further example the core is from 0.5 nm to 10 nm in diameter while the halo is from 20 nm to 1000 nm in diameter. In some embodiments, the core of the damage track comprises defects in the structure of the material. In further embodiments, a pore is formed within the damage track.

As referred to herein, spallation of a layer refers to the ejection or vaporization of material from the layer when impacted by energetic particles. In some embodiments described herein, the support layer is on the “backside” of the layer of two-dimensional material. Therefore, at least a portion of the energetic particles interact with the two-dimensional material before interacting with the underlying support, with a plurality of energetic particles passing through the layer of two dimensional material before interacting the underlying support. In some embodiments, a backside layer can have a much higher stopping power for the energetic particles than does the graphene or other two-dimensional material. For example, the backside layer can have a thickness that is significantly greater than that of the graphene or other two-dimensional material. Upon stopping the energetic ions, the backside layer can disperse an impact energy of energetic particles with the backside layer into an area of the graphene or other two-dimensional material surrounding the defects created upon interacting the ions with the two-dimensional material and promoting the expansion of the defects into holes. In more specific embodiments, a backside layer promotes expansion of defects in a two-dimensional material into holes. The backside layer may also promote formation of defects in the two-dimensional material. For example, even when an energetic particle does not form a hole when passing through the two-dimensional material, impact of the energetic particle with the backside layer may cause a small region in the backside layer to rapidly heat and expand, opening a hole in the graphene or other two-dimensional material.

In some embodiments, a spallation modifying layer is disposed between the layer of two-dimensional material and the rest of the support so that the spallation modifying layer becomes the “backside layer” In some embodiment, the spallation modifying layer promotes spallation of material so that more material is ejected from the spallation modifying layer than would be ejected from the underlying support layer. In other embodiments, the spallation modifying layer reduces spallation of material so that less material is ejected from the spallation modifying layer than would be ejected from the underlying support layer. In some embodiments the thickness of the spallation modifying layer is 1 nm to 10 nm In an embodiment, the spallation modifying material comprises material(s) with an atomic number greater than or equal to 70. Gold is an example of such a material. As an example, the layer of spallation modifying material is crystalline rather than amorphous. In embodiments, the stopping energy of the membrane is similar to that of the impinging ion.

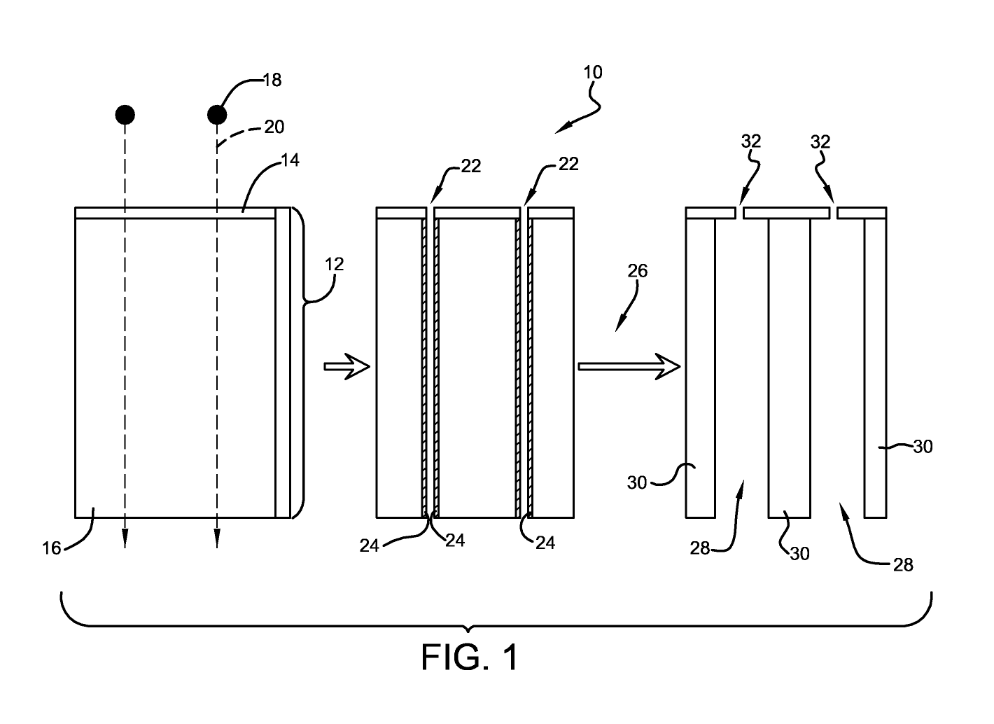

Referring now to FIG. 1, it can be seen that an exemplary method of forming a nanoporous membrane is designated generally by the numeral 10. Initially, a composite film 12 is provided wherein the film 12 includes an atomically thin material in the form of a layer 14 laminated to a non-porous polymer film 16. The composite film 12 may be provided by laminating the atomically thin material layer 14 to the polymer film 16 in a hot press manufacturing operation wherein the film 12 and layer 14 are brought together and raised to a sufficient temperature so as to at least provide a minimal interconnection force between the film 12 and the layer 14. Other methods could be employed to form the composite film 12. In the embodiment presented below, the atomically thin material is graphene. Other atomically thin materials that could be used for the layer 14 include, but are not limited to, few layer graphene, molybdenum disulfide, boron nitride, hexagonal boron nitride, niobium diselenide, silicene, and germanene.

In one embodiment, and as discussed above, the graphene layer is a single-atomic-layer-thick layer of carbon atoms, bound together to define a sheet. The thickness of a single graphene layer, which may be referred to as a membrane or a sheet, is approximately 0.34 nanometers (nm). In some embodiments, multiple graphene layers can be formed, having greater thickness and correspondingly greater strength than a single layer. Multiple graphene sheets can be provided in multiple layers as the membrane is grown or formed. Or multiple graphene sheets can be achieved by layering or positioning one graphene layer on top of another. For all the embodiments disclosed herein, a single layer of graphene or multiple graphene layers, sometimes referred to as few layer graphene, may be used. Testing reveals that multiple layers of graphene maintain their integrity and function as a result of self-adhesion. This improves the strength of the membrane and in some cases flow performance. Once perforated, in methods to be discussed, the graphene layer provides high-flux throughput material that significantly improves filtration properties, as opposed to polyimide or other polymeric material filtration materials. In most embodiments, the graphene membrane is 0.5 to 2 nanometers thick. But thicknesses up to 10 nanometers or more can be employed. In any event, the dimension and configuration of the interstitial aperture and the electron nature of the graphene precludes transport of any molecule across the graphene's thickness unless there are perforations. The interstitial aperture dimension is much too small to allow the passage of either water or ions.

The non-porous polymer film 16 in some embodiments is a polycarbonate film having a thickness ranging anywhere from ten microns to thousands of microns thick. In most embodiments, the thickness of the polymer film 16 will range from twenty-five microns to two hundred and fifty microns. Other materials such as polyester, polyimide, polypropylene, polyvinylidene fluoride, or poly methyl methacrylate or the like may be used for the film.

The next step in the method 10 is to generate energetic particles 18. the composite film 12 in a bombardment operation designated generally by the numeral 20. In one embodiment, the energetic particles are directed toward the layer 14 which may be graphene or other atomically thin material as indicated above. However, in other embodiments it is believed that the energetic particles 18 could be directed by bombardment toward the polymer film 16 side of the composite film 12. Skilled artisans will appreciate that the term bombardment may also be referred to as irradiating.

As schematically illustrated in FIG. 1, the particles 18 pass through the film leaving a “track” of chemical functionality. In embodiments, the “track” dimensions are on the subnanometer to nanometer scale.

As shown in FIG. 1, the bombardment of the energetic particles 18 form a track pore 22 through the film 12. The track pores 22 are of a uniform size and can range anywhere from 0.5 nm in diameter to 10 nm in diameter. The diameter size of the pore is determined by the bombardment step 20 and the selection of the particular type of energetic particles 18. Skilled artisans will appreciate that various factors can be used in the selection of the energetic particles and the bombardment step so as to directly affect the diameter size. These factors include but are not limited to residence time that the energetic particles are bombarded against the composite film, the types of particles or materials selected for the energetic particles, and other factors such as particle flux. As illustrated in FIG. 1, the energetic particles 18 selected for use in the bombardment step form a chemical functionalization 24 along the entire surface of the track pores 22 in the polymer film 16. Skilled artisans will appreciate that the chemical functionalization 24 of the pores 22 alters the chemical nature of the polymer film material. In embodiments the portion of the pore extending through the layer 14 may be functionalized by the irradiation, but the functionality will be inert to the further chemical process to be described.

As shown in FIG. 1, the composite film 12 undergoes an etching process 26 upon completion of the bombarding step 20. In this process 26 the entire film 12 is immersed in an appropriate fluid or gas. In the case of polycarbonate, sodium hydroxide solution is used for a predetermined period of time. Depending upon the polymer used for the polymer film 16, other types of etching fluid or gas may be used.

In embodiments, the fluid or gas in the etching process attacks the chemical functionalization 24 of the polymer material in the pores 22 so as to effectively remove the chemical functionalization area and widen or increase the diameter of the track pores 22 to form enlarged pores 28 through the polymer film 16. In embodiments where the pore 22 is inert to the etchant, the etching step does not alter in any significant way the pore 22 associated with or extending through the layer 14.

In one embodiment, it will be noted by skilled artisans that any imperfections in the graphene film or layer 14 can be mitigated by adding additional layers of graphene. As such, the probability of overlapping imperfections in the graphene layer is lowered significantly with each additional layer. Due to their atomic-scale thickness, added graphene layers should not alter the penetration of the energetic particles 18 through the composite film 12. In any event, the plurality of enlarged pores 28 is provided in the polymer film layer 16. Depending upon the amount of chemical functionalization of 24 and the parameters of the etching process 26, the size and diameter of the pores can be controlled.

In the present embodiment the diameter of the pores 28 may range from 10 nm to 1000 nm and are of a consistently uniform size as determined by those parameters. As a result of the etching process a residual polymer structure 30 is provided for supporting the adjacent side of the layer 14. The end result of the etching process provides for, in the present embodiment, a layer 14 which has a plurality of graphene apertures or pores 32 which may have a diameter of 0.5 to 10 nm in diameter. Moreover, the graphene apertures 32 are concentrically aligned with the enlarged pores 28. As an example, pores and perforations are aligned when the pores and perforations overlap at the faces of adjacent layers of the composite structure. As a result, the composite film 12 is provided with concentrically aligned graphene pores and polymer film pores in a maximized number so as to provide a one-to-one mapping of holes in both the active membrane (the graphene) and the substrate/support (the polymer). It can also be said that a graphene pore and the polymer film pore formed by the etching process are coincident with one another in that the graphene pore and the polymer film pore are contiguous with one another. Use of other thin materials disclosed above with a polymer film and bombardment process will provide a similar nanoporous membrane.

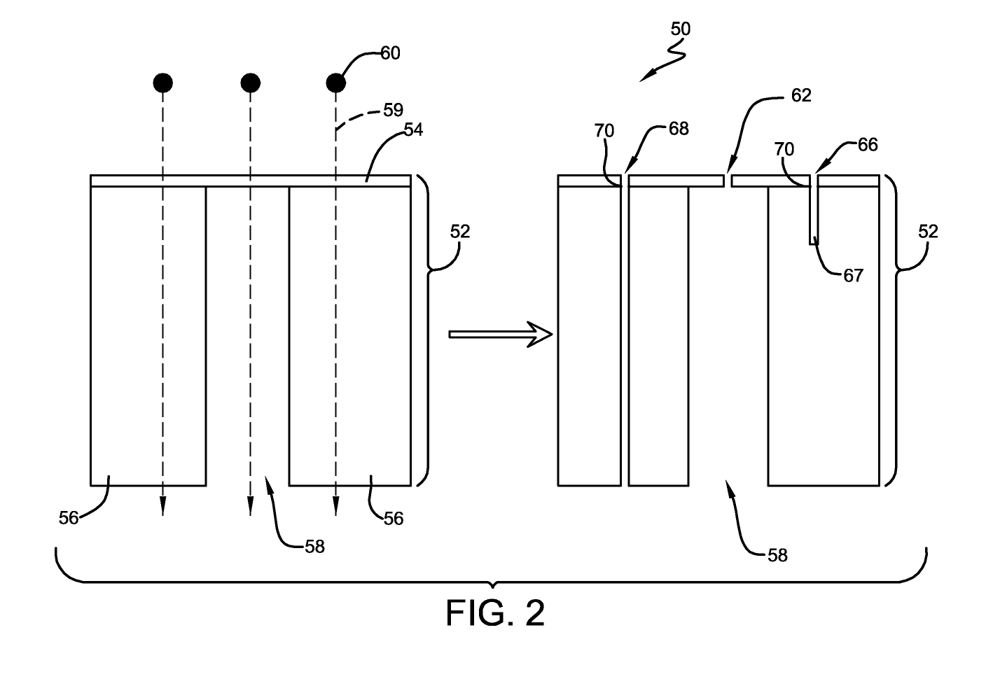

Referring now to FIG. 2 an alternative methodology for forming a nanoporous membrane is designated generally by the numeral 50. This embodiment is similar to the methodology shown in FIG. 1 except that a porous membrane is initially laminated to a graphene membrane in a manner employed in the first embodiment. In particular, the methodology 50 utilizes a composite film 52 which utilizes a graphene layer 54 substantially the same as the graphene layer 14. Moreover, all of the characteristics of the graphene layer 14 are provided by the graphene layer 54. In this particular embodiment, the porous polymer layer 56 may be constructed of polycarbonate, polyester, polyimide, polypropylene, polyvinylidene fluoride, poly methyl methacrylate, or other similar materials. The polymer layer 56 is provided with enlarged pores designated generally by the numeral 58.

In the present embodiment the composite film 52 is bombarded in a process 59 by energetic particles 60. The energetic particles selected are similar to those in the previous embodiment; however, they are selected so as not to generate a chemical functionalization of any pores formed in the polymer layer 56 by the bombardment process 59.

In this embodiment, the porous polymer layer 56 is provided with enlarged pores 58 having a diameter of 10 to 1000 nm. Skilled artisans will appreciate that the diameter of the enlarged pores 58 could be even larger than 1000 nm. In any event, bombardment of the energetic particles 60 is directed toward the graphene layer 54, but it will be appreciated that the bombardment may occur by projecting the particles 60 at the porous polymer layer 56. In this embodiment, the energetic particles may be selected so that the polymer layer or film is left chemically inert toward pore enlargement.

As a result of the bombardment process 59 a plurality of pores 62 are generated that extend through the graphene layer 54. The pore 62 is aligned with the enlarged pore 58 and may or may not be concentric therewith. The bombardment also results in formation of a pore 66 that extends through the graphene and only partially into the polymer layer 56 so as to form a cavity 67. And in some cases the particles 60 generate a pore 68 that extends all the way through both the graphene layer 54 and the polymer layer 56. It will further be appreciated that a chemical bond 70 may be formed between the graphene layer 14 and the polymer layer 56 so as to further secure the polymer layer 56 to the graphene layer 54. As a result, the disclosed embodiment provides for alignment of pores 62 to having a diameter ranging from 0.5 nm to 10 nm wherein the underlying pore 58 has an enlarged diameter which may be concentric therewith. Moreover, in this embodiment more than one hole or pore can be made in the graphene layer 54 per pore in the polycarbonate or polymer film layer 56 leading to higher permeability. As a result of the bombardment process, it will be appreciated that a number of pores 58 are aligned with a number of pores 62. As such, the pore 58 and the pore 62 will be contiguous with one another to permit fluid flow therethrough. In other words, the aligned pore 58 and pore 62 may not necessarily have the same relative center point. However, after the bombardment process, a significant number of pores 58 and pores 62 will be concentrically aligned with each other. Other embodiments may employ other thin materials as disclosed above and other polymer materials.

Based on the foregoing, the advantages of the present invention are readily apparent. By covering a nonporous track etchable layer with an unperforated thin material layer before energy particle bombardment, any later formed thin material perforation is coincident with a track in the track etchable layer. As disclosed in the first embodiment, subsequent etching of the tracks leaves the graphene pore untouched in terms of diameter but creates a larger pore in the track etchable layer, which is concentric with the graphene pore, to allow for higher overall permeability of the composite membrane. As a result, one-to-one mapping of holes in both the graphene membrane and the track etchable layer allows for forming holes in the graphene and the support membrane at the same time. The disclosed methods of manufacturing a nanoporous membrane are advantageous both in terms of membrane performance and manufacturability. By having an exact coincidence between graphene perforations and pores in the support film, the permeability of the composite membrane is much higher compared to composite membranes with random hole registration. Moreover, processing the active layer and support film simultaneously is potentially much easier and more scalable from a manufacturing standpoint. Incorporating extra layers of graphene to exclude defects before perforation also allows for intentional perforations to persist through all layers of the graphene. Were the graphene layers to be perforated individually, overlapping perforations would occur only randomly, thereby decreasing membrane permeability.

In the embodiment which provides for use of a porous polymer film prior to particle bombardment an advantage can be realized by selection of a particle that can be different from the type needed to create tracks in the polycarbonate film. In other words, use of a porous polymer film may allow for flexibility in forming a composite film in the manufacturing process. Additionally, use of a porous polymer film may allow for advantages in use of the composite film. Such a construction may allow for additional flexibility of the composite film. It will further be appreciated that the embodiments disclosed may simultaneously create pores and chemically bond the graphene film to the support film so as to further strengthen the composite material.

Thus, it can be seen that the objects of the invention have been satisfied by the structure and its method for use presented above. While in accordance with the Patent Statutes, only the selected embodiments have been presented and described in detail, it is to be understood that the invention is not limited thereto or thereby. Accordingly, for an appreciation of the true scope and breadth of the invention, reference should be made to the following claims.

Although the disclosure has been described with reference to the disclosed embodiments, one having ordinary skill in the art will readily appreciate that these are only illustrative of the disclosure. It should be understood that various modifications can be made without departing from the spirit of the disclosure. The disclosure can be modified to incorporate any number of variations, alterations, substitutions or equivalent arrangements not heretofore described, but which are commensurate with the spirit and scope of the disclosure. Additionally, while various embodiments of the disclosure have been described, it is to be understood that aspects of the disclosure may include only some of the described embodiments. Accordingly, the disclosure is not to be seen as limited by the foregoing description.

Every formulation or combination of components described or exemplified can be used to practice the invention, unless otherwise stated. Specific names of compounds are intended to be exemplary, as it is known that one of ordinary skill in the art can name the same compounds differently. When a compound is described herein such that a particular isomer or enantiomer of the compound is not specified, for example, in a formula or in a chemical name, that description is intended to include each isomers and enantiomer of the compound described individual or in any combination. One of ordinary skill in the art will appreciate that methods, device elements, starting materials and synthetic methods other than those specifically exemplified can be employed in the practice of the invention without resort to undue experimentation. All art-known functional equivalents, of any such methods, device elements, starting materials and synthetic methods are intended to be included in this invention. Whenever a range is given in the specification, for example, a temperature range, a time range, or a composition range, all intermediate ranges and subranges, as well as all individual values included in the ranges given are intended to be included in the disclosure. When a Markush group or other grouping is used herein, all individual members of the group and all combinations and subcombinations possible of the group are intended to be individually included in the disclosure.

As used herein, “comprising” is synonymous with “including,” “containing,” or “characterized by,” and is inclusive or open-ended and does not exclude additional, unrecited elements or method steps. As used herein, “consisting of” excludes any element, step, or ingredient not specified in the claim element. As used herein, “consisting essentially of” does not exclude materials or steps that do not materially affect the basic and novel characteristics of the claim. Any recitation herein of the term “comprising”, particularly in a description of components of a composition or in a description of elements of a device, is understood to encompass those compositions and methods consisting essentially of and consisting of the recited components or elements. The invention illustratively described herein suitably may be practiced in the absence of any element or elements, limitation or limitations which is not specifically disclosed herein.

The terms and expressions which have been employed are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the concepts herein disclosed may be resorted to by those skilled in the art, and that such modifications and variations are considered to be within the scope of this invention as defined by the appended claims.

In general the terms and phrases used herein have their art-recognized meaning, which can be found by reference to standard texts, journal references and contexts known to those skilled in the art. The preceding definitions are provided to clarify their specific use in the context of the invention.

All references throughout this application, for example patent documents including issued or granted patents or equivalents; patent application publications; and non-patent literature documents or other source material; are hereby incorporated by reference herein in their entireties, as though individually incorporated by reference, to the extent each reference is at least partially not inconsistent with the disclosure in this application (for example, a reference that is partially inconsistent is incorporated by reference except for the partially inconsistent portion of the reference).

All patents and publications mentioned in the specification are indicative of the levels of skill of those skilled in the art to which the invention pertains. References cited herein are incorporated by reference herein in their entirety to indicate the state of the art, in some cases as of their filing date, and it is intended that this information can be employed herein, if needed, to exclude (for example, to disclaim) specific embodiments that are in the prior art. For example, when a compound is claimed, it should be understood that compounds known in the prior art, including certain compounds disclosed in the references disclosed herein (particularly in referenced patent documents), are not intended to be included in the claims.

What is claimed is:

1. A method for making a supported nanoporous membrane, the method comprising the steps of
a) providing a composite structure comprising a layer of a two-dimensional material disposed on a support, wherein the support comprises at least one layer of track etchable material;
b) irradiating said composite structure with energetic particles to form a plurality of perforations in at least said layer of two-dimensional material and to form a plurality of damage tracks through the layer of track etchable material; and
c) applying a track etchant to the support material, thereby etching at least a plurality of the tracks to form pores through the layer of track etchable material
whereby a supported nanoporous membrane is provided by the layer of perforated two-dimensional material disposed on the support.

2. The method of claim 1, wherein the perforations in the two-dimensional material are from 0.4 nm to 100 nm in size.

3. The method of claim 1, wherein the two-dimensional material is a graphene-based material comprising single layer graphene, multi-layer graphene, multiple layers of single layer graphene or multiple layers of multi-layer graphene.

4. The method of claim 1, wherein the two-dimensional material comprises molybdenum disulfide, boron nitride, hexagonal boron nitride, niobium diselenide, silicene, and germanene.

5. The method of claim 1, wherein the support is porous and comprises a plurality of pores following step c).

6. The method of claim 1, wherein the size of the pores formed in the layer of track etchable material is greater than the size of the perforations in the two-dimensional material.

7. The method of claim 5, wherein the size of the pores of the support are from 10 nm to 1000 nm in size following step c).

8. The method of claim 1, wherein the support is porous prior to execution of step c), but the size of the pores is modified during step c).

9. The method of claim 1, wherein during step b) the energetic particles are directed substantially normal to the composite structure.

10. The method of claim 1, wherein during step b) the energetic particles are directed at an angle from 0 degrees to 45 degrees with respect to the normal to the composite structure.

11. The method of claim 1, wherein during step b) the composite structure is irradiated by energetic particles directed at a first angle from 0 degrees to 45 degrees with respect to the normal to the composite structure and then irradiated by energetic particles directed at a second angle from 0 degrees to 45 degrees, the second angle being different from the first angle.

12. The method of claim 1, further comprising the step of applying a two-dimensional material etchant to the two-dimensional material, thereby increasing the size of the perforations in the two-dimensional material.

13. The method of claim 1, wherein during step c) the size of the perforations in the two-dimensional material is not modified.

14. The method of claim 1, wherein during step c) the size of the perforations in the two-dimensional material is increased.

15. The method of claim 1, wherein the support comprises a single layer of track etchable material and the layer of two-dimensional material is disposed on a first face of the layer of track etchable material.

16. The method of claim 15, wherein during step c) the etchant is applied to a second face of the layer of track etchable material, the second face of the layer of track etchable material being opposite the first face.

17. The method of claim 16, wherein the pores formed through the layer of track etchable material are larger in diameter at the exposed face of the layer of track etchable material than at the opposite face.

18. The method of claim 16, wherein during step c) the etchant is also applied to the layer of track etchable material through pores formed in the layer of two-dimensional material.

19. The method of claim 1, wherein the support comprises a single layer of track etchable material and a spallation modification layer, with a first face of the layer of track etchable material being disposed on a first face of the spallation modification layer and the layer of two-dimensional material being disposed on the second face of the spallation modification layer. the second face of the spallation modification layer being opposite the first face and wherein during step b) a pore or a damage track is formed in the spallation control layer.

20. The method of claim 19 wherein during step c) the etchant is applied to a second face of the layer of track etchable material, the second face of the layer of track etchable material being opposite the first face.

21. A supported nanoporous membrane comprising:
a layer of perforated two-dimensional material comprising perforations, wherein the perforations are from 0.4 nm to 100 nm in size; and
a porous support comprising pores
wherein the layer of perforated two-dimensional material is disposed on the porous support and a plurality of the pores of the porous support are aligned with the perforations of the perforated two-dimensional material.

22. The supported nanoporous membrane of claim 21, wherein a plurality of the pores of the porous support are larger in size than the perforations of the perforated two-dimensional material.

23. The supported nanoporous membrane of claim 21, wherein the pores of the porous support are from 10 nm to 1000 nm in size.

24. The supported nanoporous membrane of claim 21, wherein the two-dimensional material is a graphene-based material comprising single layer graphene, multi-layer graphene, multiple layers of single layer graphene or multiple layers of multi-layer graphene

25. The supported nanoporous membrane of claim 21, wherein the two-dimensional material comprises molybdenum disulfide, boron nitride, hexagonal boron nitride, niobium diselenide, silicene, and germanene.
